(19) United States
(12) Patent Application Publication
(10) Pub. No.: US 2022/0085908 A1
(43) Pub. Date: Mar. 17, 2022

(54) DYNAMIC NUMEROLOGY FOR LINK ADAPTATION

(71) Applicant: QUALCOMM Incorporated, San Diego, CA (US)

(72) Inventor: Ronen SHAKED, Kfar Saba (IL)

(21) Appl. No.: 17/023,250

(22) Filed: Sep. 16, 2020

(51) Int. Cl. H04L 1/00; H04W 72/08; H04L 27/26

(52) U.S. Cl. CPC H04L 1/0003; H04L 27/2605; H04W 72/082

(57) ABSTRACT

A user equipment (UE) and a base station utilize dynamic numerology for adaptation of a link between the UE and the base station. The UE may determine a recommended subcarrier spacing to use for a downlink transmission based on the modulation and coding scheme to be used for the downlink transmission and transmit the recommended subcarrier spacing to the base station. The UE may also transmit a report containing channel state information to the base station and the base station may determine the subcarrier spacing to use for the downlink transmission based on the report.

### BACKGROUND

### Technical Field

The present disclosure relates generally to communication systems, and more particularly, to a wireless communication system utilizing dynamic numerology.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The UE may determine a modulation and coding scheme for communicating with a base station and a target noise floor corresponding to the modulation and coding scheme, determine a recommended subcarrier spacing based on the target noise floor, and report the determined recommended subcarrier spacing to the base station.

In some aspects, determining the recommended subcarrier spacing may include determining a residual phase noise floor corresponding to the recommended subcarrier spacing, and determining that the residual phase noise floor is below the target noise floor.

In some aspects, determining the recommended subcarrier spacing may include determining a residual phase noise floor corresponding to the recommended subcarrier spacing, and determining that the residual phase noise floor is at least a threshold value below the target noise floor.

In some aspects, determining the recommended subcarrier spacing may include determining a number of inter carrier interference correction coefficients to utilize in phase noise correction, determining a residual phase noise floor corresponding to the recommended subcarrier spacing based on the number of inter carrier interference correction coefficients, and determining that the residual phase noise floor is below the target noise floor.

In some aspects, determining the recommended subcarrier spacing based on the target noise floor may include determining the recommended subcarrier spacing based on a channel estimation noise floor associated with a channel delay spread of a channel, wherein the modulation and coding scheme is for communicating with the base station on the channel.

In some aspects, determining the recommended subcarrier spacing based on the target noise floor may include determining the recommended subcarrier spacing further based on a number of inter carrier interference correction coefficients to utilize in phase noise correction.

In some aspects, determining the recommended subcarrier spacing may include determining a cyclic prefix overhead value corresponding to the recommended subcarrier spacing based on the channel delay spread, and determining that the cyclic prefix overhead value is below a target cyclic prefix overhead value.

In another aspect of the disclosure, a method, a computer-readable medium, and an apparatus are provided. The apparatus may be a base station. The base station may receive, from a UE, a modulation and coding scheme for a downlink transmission on a channel to the UE, receive, from the UE, a report comprising a channel delay spread for the channel, determine a subcarrier spacing for the downlink transmission based on the channel delay spread and the modulation and coding scheme, and transmit the downlink transmission to the UE using the determined subcarrier spacing.

In some aspects, the base station may receive, from the UE, a candidate subcarrier spacing for the downlink transmission, and determine the subcarrier spacing for the downlink transmission further based on the received candidate subcarrier spacing.

In some aspects, the candidate subcarrier spacing may be based on a residual phase noise floor corresponding to the candidate subcarrier spacing or a number of inter carrier interference correction coefficients for the UE.

In some aspects, the base station may transmit the determined subcarrier spacing to the UE.

In some aspects, determining the subcarrier spacing for the downlink transmission may include determining a cyclic prefix overhead value corresponding to the subcarrier spacing based on the channel delay spread, and determining that the cyclic prefix overhead value is below a target cyclic prefix overhead value.

In some aspects, the base station may receive a phase noise floor corresponding to the subcarrier spacing from the UE, and determine the subcarrier spacing for the downlink transmission further based on the phase noise floor corresponding to the subcarrier spacing from the UE.

In some aspects, the base station may receive an inter carrier interference correction coefficient configuration from the UE, and determine the subcarrier spacing for the downlink transmission further based on the inter carrier interference correction coefficient configuration.

In some aspects, the base station may determine a number of inter carrier interference correction coefficients for the UE based on the inter carrier interference correction coefficient configuration and the determined subcarrier spacing, and transmit the number of inter carrier interference correction coefficients to the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G NR frame, DL channels within a 5G NR subframe, a second 5G NR frame, and UL channels within a 5G NR subframe, respectively.

FIG. 3 is a diagram illustrating an example of a base station and user equipment (UE) in an access network.

FIG. 4 is a diagram illustrating downlink communication between a base station and a UE.

FIG. 5 is a communication flow diagram illustrating dynamic numerology in downlink communication based on residual phase noise floor.

FIG. 6 is a graph showing the residual phase noise floor on a channel for a receiver based on the number of ICI correction coefficients used and the subcarrier spacing of the channel.

FIG. 7 is a communication flow diagram illustrating dynamic numerology in downlink communication based on residual phase noise floor and a number of ICI correction coefficients used.

FIG. 8 is a graph showing the residual phase noise floor on a channel for a receiver based on the number of ICI correction coefficients used and the subcarrier spacing of the channel.

FIG. 9 is a communication flow diagram illustrating dynamic numerology in downlink communication based on channel delay spread.

FIG. 10 is a graph showing the residual phase noise floor on a channel for a receiver based on the number of ICI correction coefficients used and the subcarrier spacing of the channel.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an apparatus.

FIG. 15 is a diagram illustrating an example of a hardware implementation for an apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

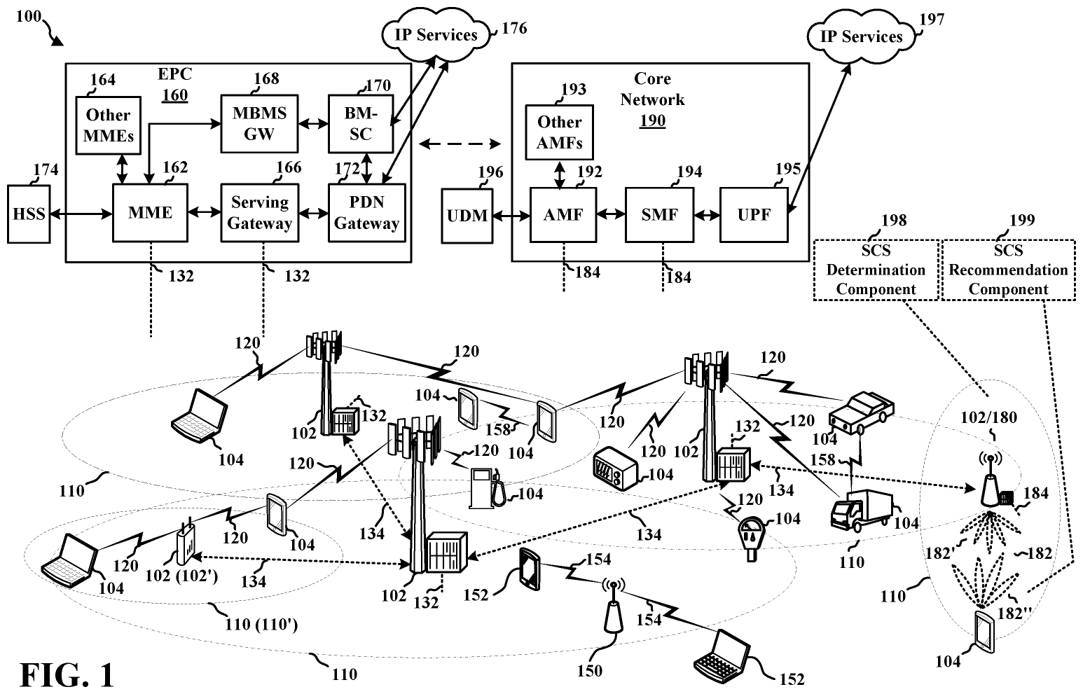

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Frequency range bands include frequency range 1 (FR1), which includes frequency bands below 7.225 GHz, and frequency range 2 (FR2), which includes frequency bands above 24.250 GHz. Communications using the mmW/near mmW radio frequency (RF) band (e.g., 3 GHz-300 GHz) has extremely high path loss and a short range. Base stations/UEs may operate within one or more frequency range bands. The mmW base station 180 may utilize beamforming 182 with the UE 104 to compensate for the extremely high path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a SCS recommendation component 199 configured to determine a recommended SCS for a downlink transmission from the base station 180 to the UE 104, and to transmit the recommended SCS to the base station 180. In certain aspects, the base station 180 may include a SCS determination component 198 configured to receive a recommended SCS from the UE 104 and to determine the SCS for a downlink transmission to the UE 104 based on the recommended SCS. Although the following description may be focused on 5G NR, the concepts described herein may be applicable to other similar areas, such as LTE, LTE-A, CDMA, GSM, and other wireless technologies.

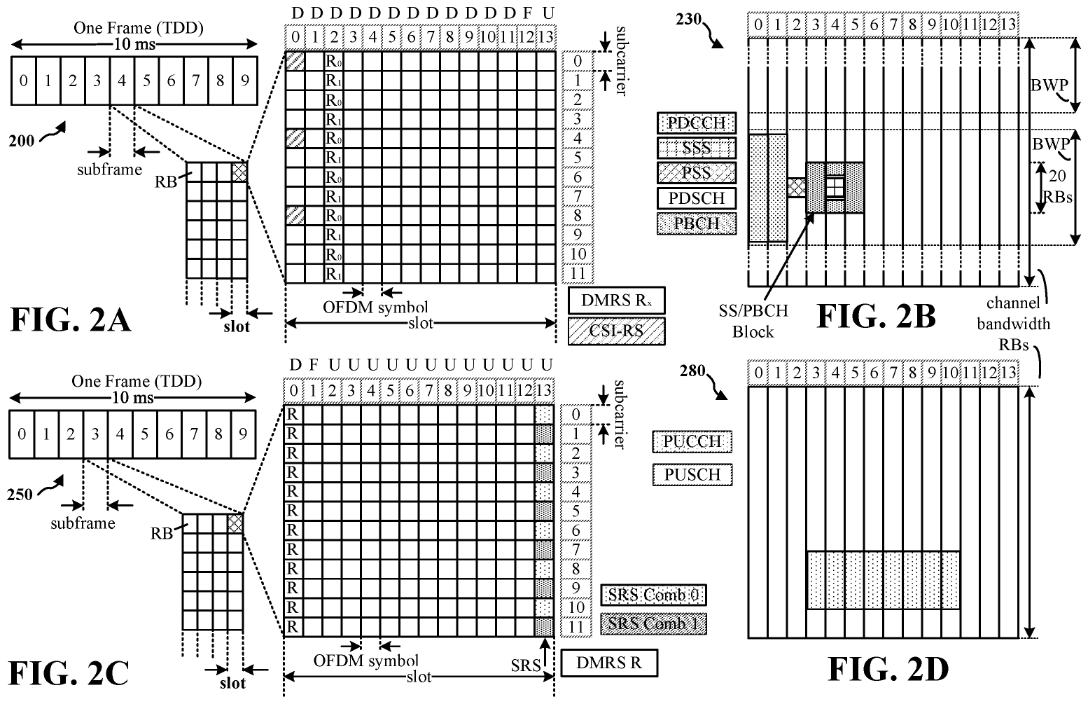

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

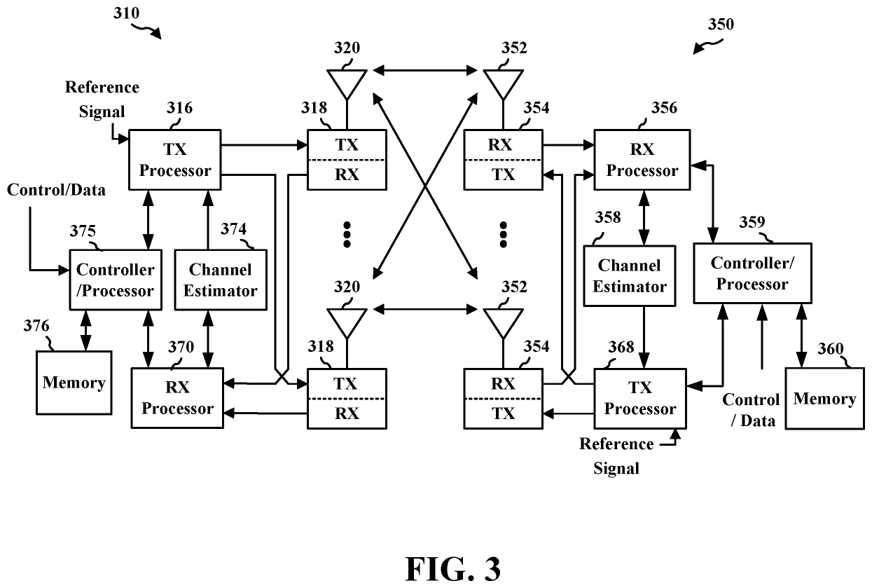

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission. The channel estimator 374 can introduce channel estimate noise which can be considered as a noise floor contributing to a total noise floor. Various aspects described herein can relate to determining a subcarrier spacing such that the total noise floor is below a target noise floor, for example, below the target noise floor by a target noise floor threshold. Another source of noise can include residual phase noise resulting from phase noise estimation and correction, as will be described further elsewhere herein.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

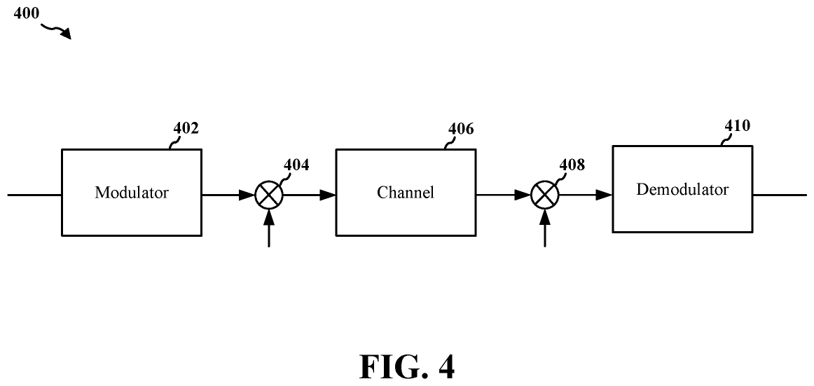

FIG. 4 is a diagram 400 illustrating downlink communication between a base station and a UE. The base station includes a modulator 402. For example, the modulator 402 may be an OFDM modulator. When transmitting a downlink transmission to the UE, the modulator 402 modulates the signal to be transmitted based on the modulation and coding scheme (MCS) for the transmission. An up-converter 404 converts the modulated signal to the frequency at which the signal will be transmitted. The signal is then transmitted to the UE through the channel 406.

The UE includes a demodulator 410. Upon receiving the transmission, a down-converter 408 converts the signal from the transmitted frequency back to the original frequency. The down-converted signal is then demodulated by the demodulator 410 based on the MCS for the transmission.

The up-converter 404 may include a transmit local oscillator and the down-converter 408 may include a receive local oscillator, both of which are used to perform the respective frequency conversions. The transmit local oscillator and the receive local oscillator may introduce phase noise into the signal received at the UE, which may result in inter-channel interference (ICI).

Multiple MCSs may be used by the modulator 402 and the demodulator 410 to encode and decode the transmission. MCSs may have different sensitivity to noise (e.g., MCS with a higher spectral efficiency may have a lower signal-to-noise ratio), so whether a given MCS can be used for the downlink transmission may depend on the noise floor of the transmission received at the UE. Accordingly, each MCS may have a corresponding target noise floor, and that MCS may not be used if the noise floor of the downlink transmission is above the target noise floor (or less than a threshold value below the target noise floor). The phase noise introduced by the transmit local oscillator and the receive local oscillator may be a component of the noise floor of the downlink transmission.

To reduce the noise floor in the downlink transmission, the UE (e.g., a receiver of the UE) may perform phase noise suppression. In some aspects, the phase noise may be modeled based on the fast Fourier transform (FFT) coefficients of the phase noise. In phase noise suppression, the UE may determine the values of a number of ICI correction coefficients representing the values of FFT coefficients of the phase noise. The UE may then use the values of the ICI coefficients to suppress the phase noise in the received downlink transmission.

In some aspects, the phase noise may be modeled or approximated based on other types of coefficients, or an estimation or an approximation of the other types coefficients, and the UE may determine the value of a number of ICI correction coefficients approximating the other types of coefficients. For example, in some aspects, the UE may determine a number of ICI correction coefficients based on least squares estimation of the phase noise.

The number of ICI correction coefficients which the UE determines in phase noise suppression may be finite. A larger number of ICI correction coefficients used may result in a more accurate representation of the phase noise, which may result in a larger reduction in the phase noise floor component of the noise floor.

The amount of phase noise on the received downlink transmission may be based on the subcarrier spacing (SCS) used for the transmission. A sub-carrier with wider SCS may be farther from its neighboring sub-carriers, which may result in a lower phase noise floor due to lower leakage power and/or lower ICI.

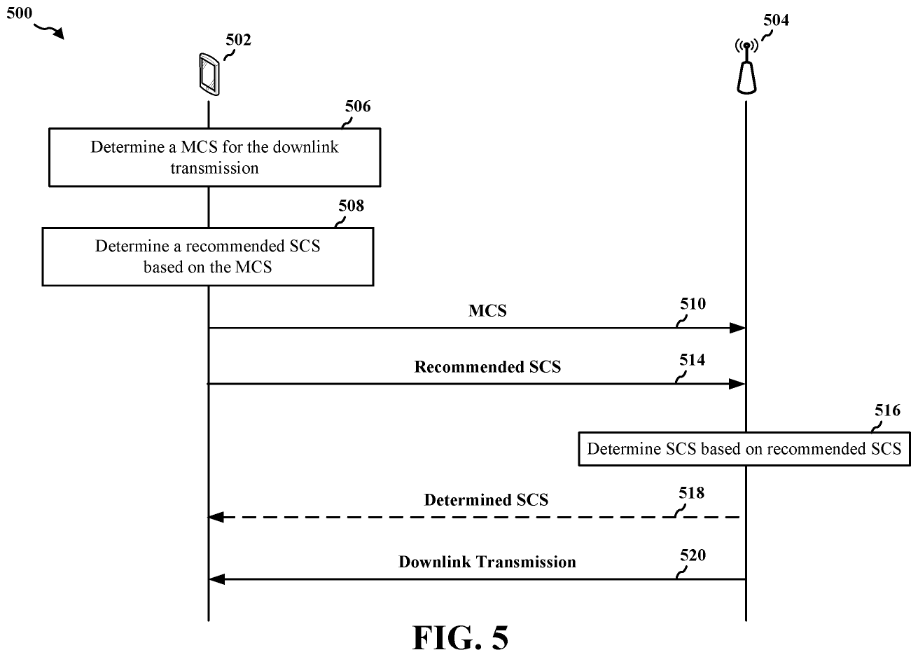

FIG. 5 is a communication flow diagram 500 illustrating dynamic numerology in downlink communication based on residual phase noise floor. A base station 504 may be attempting to transmit a downlink transmission to a UE 502. As illustrated at 506, the UE 502 may determine a MCS to use for the downlink transmission. For example, the UE 502 may determine the noise floor for the channel on which the downlink transmission will be sent, and may select a MCS by or based on comparing the target noise floor of the MCS to the noise floor for the channel (e.g., may select a MCS with a target noise floor that is above the noise floor for the channel, or may select a MCS with a target noise floor that is at least a threshold level above the noise floor for the channel).

In some aspects, the UE may select the MCS based on comparing the target noise floor of the MCS to the thermal noise floor for the channel or an estimate of the thermal noise floor for the channel. The UE may estimate the thermal noise floor and select a MCS fitted to the estimated thermal noise floor, such that that the residual phase noise floor and/or the channel noise floor are not the dominant noise floor on the channel (e.g., the residual phase noise floor and/or the channel noise floor may be 6-10 dB below the thermal noise floor). As the channel noise floor and/or the residual phase noise floor may not be dominant with respect to the thermal phase noise floor, a range of potential SCS may be usable for communication on the channel utilizing the selected MCS.

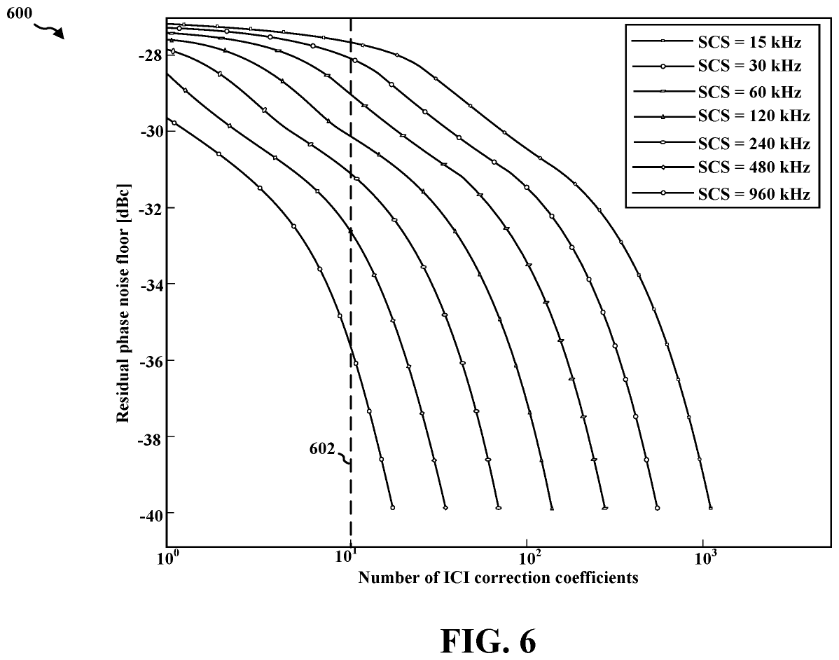

As illustrated at 508, the UE 502 may determine a recommended SCS based on the selected MCS. The recommended SCS may be determined based on whether the noise floor or the phase noise floor that would remain after phase noise suppression would be below the target noise floor for the MCS (or would be at least a threshold value below the target noise floor). For example, FIG. 6 is a graph 600 showing the residual phase noise floor on a channel for a receiver based on the number of ICI correction coefficients used and the subcarrier spacing of the channel. The UE 502 may be configured to utilize ten ICI correction coefficients in phase noise suppression. Accordingly, line 602 illustrates the residual phase noise floor after phase noise suppression which the UE 502 will expect for various SCSs. The UE 502 may select a SCS corresponding to a residual phase noise at line 602 which would result in a noise floor below the target noise floor for the MCS. For example, if a residual phase noise of −32 decibels relative to carrier (dBc) or lower would satisfy the target noise floor for the MCS, the UE 502 may select 960 kHz or 480 kHz as the recommended SCS, but may not select 240 kHz, 120 kHz, 60 kHz, 30 kHz, or 15 kHz as the recommended SCS. In some aspects, the UE 502 may select the narrowest SCS corresponding to a residual phase noise at line 602 which would result in a noise floor below the target noise floor for the MCS (e.g., the UE 502 may select 480 kHz as the recommended SCS).

In some aspects, the UE 502 may additionally determine the recommended SCS based on a latency target for the UE 502. For example, the UE 502 may expect to transmit data with a certain latency requirement or quality of service requirement (e.g., ultra-reliable low-latency communication (URLLC)) on the channel. Wider subcarrier spacing may result in shorter symbol length and therefore lower latency. The UE 502 may determine a recommended SCS that satisfies its latency target for the traffic it expects to transmit on the channel.

In some aspects, the UE 502 may determine the MCS as illustrated at 506, and subsequently the UE 502 may determine the recommended SCS as illustrated at 508 such that the recommended SCS results in a noise floor which satisfies the target noise floor for the MCS. In some aspects, the UE 502 may determine the MCS as illustrated at 506 and determine the recommended SCS as illustrated at 508 in coordination, such that a MCS and a recommended SCS are determined which result in a noise floor which satisfies the target noise floor for the selected MCS.

The UE 502 may transmit the determined MCS 510 and the determined recommended SCS 514 to the base station 504. As illustrated at 516, the base station 504 may determine a SCS that will be used for the downlink transmission based on the recommended SCS 514. In some aspects, the base station 504 may determine the recommended SCS 514 to be the SCS for the downlink transmission.

In some aspects, the base station 504 may receive recommended SCSs from multiple UEs, and may determine the SCS for the downlink transmission based on the multiple recommended SCSs. For example, in some aspects, the base station 504 may determine to use the widest recommended SCS received from a UE in the same band or sub-band as the UE 502 as the SCS for the downlink transmission to the UE 502. In some aspects, the base station 504 may determine that it received a recommended SCS from a UE serving a latency-sensitive communication (e.g., URLLC) in the same band or sub-band as the UE 502, may determine to use a SCS with a width that allows the base station 504 to meet the latency target for the latency-sensitive communication, and may use that SCS for transmissions on the band or sub-band, including for the downlink transmission to the UE 502. In some aspects, the base station 504 may transmit the determined SCS 518 to the UE 502.

Finally, the base station 504 may transmit the downlink transmission 520 to the UE 502 using the determined MCS 510 and the SCS determined at 516 (e.g., the recommended SCS), and the UE 502 may receive the downlink transmission 520 using the determined MCS 510 and the SCS determined at 516.

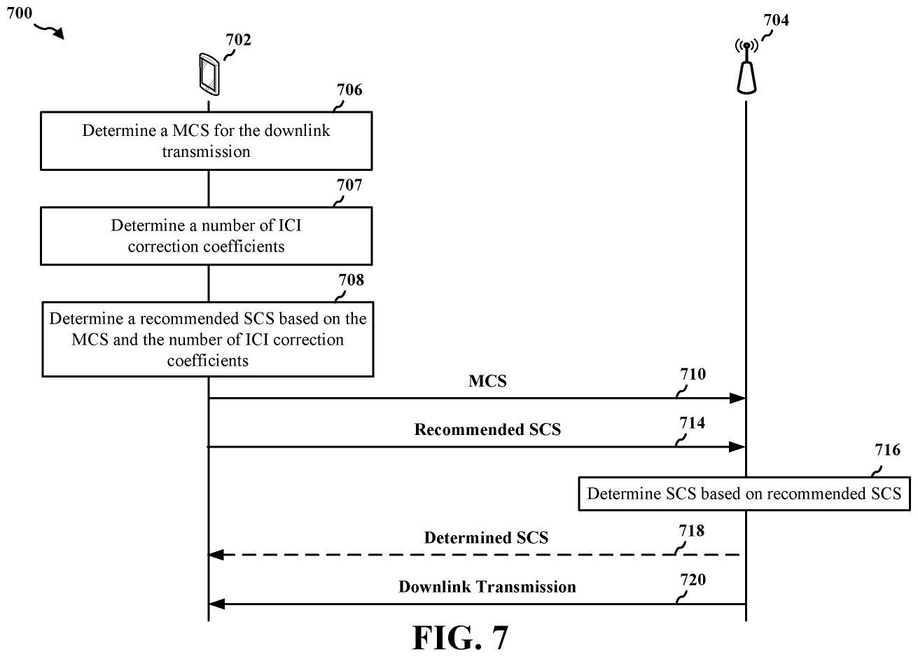

FIG. 7 is a communication flow diagram 700 illustrating dynamic numerology in downlink communication based on residual phase noise floor and a number of ICI correction coefficients used. A base station 704 may be attempting to transmit a downlink transmission to a UE 702. As illustrated at 706, the UE 702 may determine a MCS to use for the downlink transmission. For example, the UE 702 may determine the noise floor for the channel on which the downlink transmission will be sent, and may select a MCS by comparing the target noise floor of the MCS to the noise floor for the channel (e.g., may select a MCS with a target noise floor that is above the noise floor for the channel, or may select a MCS with a target noise floor that is at least a threshold level above the noise floor for the channel).

As illustrated at 707, the UE 702 may determine a number of ICI correction coefficients which the UE 702 will use in phase noise suppression. The UE 702 may be configured to utilize a variable number of ICI coefficients, and may be configured to determine how many to utilize in performing phase noise suppression for a particular downlink transmission. A larger number of ICI correction coefficients may result in a larger suppression of phase noise, but may also result in increased power consumption and/or increased compute resource usage. In some aspects, the UE 702 may be configured with a policy determining how many ICI correction coefficients to use, and may determine the number of ICI correction coefficients based on the policy. For example, the UE 702 may be configured to utilize up to 100 ICI correction coefficients, and the policy may indicate that the maximum number of ICI correction coefficients should be used if battery power is at 25% or greater, but that 10 ICI correction coefficients should be used if battery power is below 25%; the UE 702 may determine 100 to be the number of ICI correction coefficients at 707 if the battery power is at 25% or greater, and the UE 702 may determine 10 to be the number of ICI correction coefficients at 707 if the battery power is below 25%. As another example, the UE 702 may be configured with a power saving mode (e.g., not necessarily triggered based on battery level) and the policy may indicate different numbers of ICI correction coefficients that can be used when the UE 702 is in power saving mode and when the UE 702 is not in power saving mode; the UE 702 may determine 100 to be the number of ICI correction coefficients at 707 if the UE 702 is not in power saving mode, and the UE 702 may determine 10 to be the number of ICI correction coefficients at 707 if the UE 702 is in power saving mode.

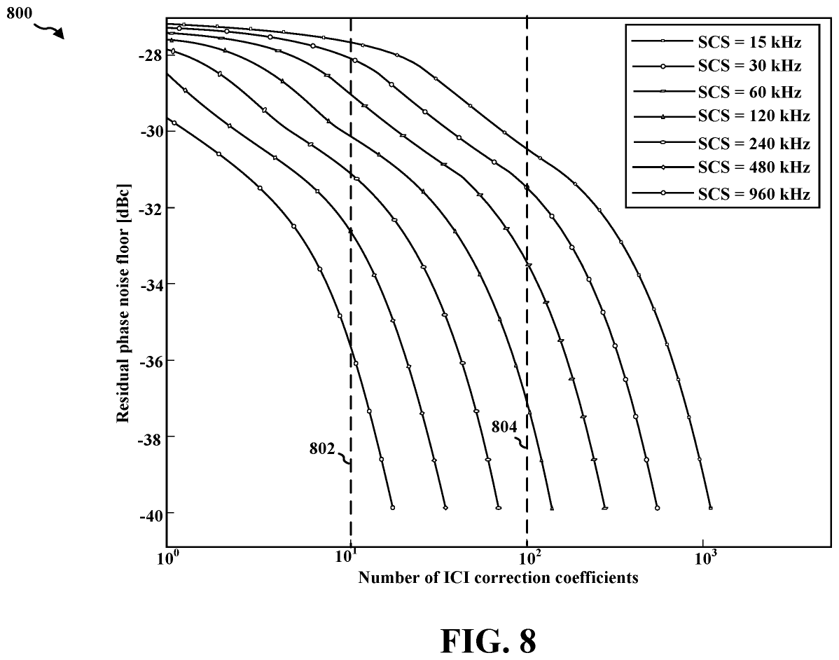

As illustrated at 708, the UE 702 may determine a recommended SCS based on the selected MCS and the determined number of ICI correction coefficients. The recommended SCS may be determined based on whether the noise floor or the phase noise floor that would remain after phase noise suppression, performed using the determined number of ICI correction coefficients, would be below the target noise floor for the MCS (or would be at least a threshold value below the target noise floor). For example, FIG. 8 is a graph 800 showing the residual phase noise floor on a channel for a receiver based on the number of ICI correction coefficients used and the subcarrier spacing of the channel. Line 802 illustrates the residual phase noise floor after phase noise suppression which the UE 702 will expect for various SCSs if 10 ICI correction coefficients are used. Line 804 illustrates the residual phase noise floor after phase noise suppression which the UE 702 will expect for various SCSs if 10 ICI correction coefficients are used. The UE 702 may select a SCS corresponding to a residual phase noise, after phase noise correction using the number of ICI correction coefficients determined at 707, which would result in a noise floor below the target noise floor for the MCS. For example, if a residual phase noise of −32 dBc or lower would satisfy the target noise floor for the MCS, and if the UE 702 determined to use 10 ICI correction coefficients, then the UE 702 may select 960 kHz or 480 kHz as the recommended SCS, but may not select 240 kHz, 120 kHz, 60 kHz, 30 kHz, or 15 kHz as the recommended SCS. If a residual phase noise of −32 dBc or lower would satisfy the target noise floor for the MCS, and if the UE 702 determined to use 100 ICI correction coefficients, then the UE 702 may select 960 kHz, 480 kHz, 240 kHz, 120 kHz, or 60 kHz as the recommended SCS, but may not select 30 kHz or 15 kHz as the recommended SCS. In some aspects, the UE 702 may select the narrowest SCS corresponding to a residual phase noise, based on the number of ICI coefficients determined at 707, which would result in a noise floor below the target noise floor for the MCS (e.g., the UE 702 may select 480 kHz as the recommended SCS if 10 ICI correction coefficients will be used, and the UE 702 may select 60 kHz as the recommended SCS if 100 ICI correction coefficients will be used).

The UE 702 may transmit the determined MCS 710 and the determined recommended SCS 714 to the base station 704. As illustrated at 716, the base station 704 may determine a SCS that will be used for the downlink transmission based on the recommended SCS 714. In some aspects, the base station 704 may determine the recommended SCS 714 to be the SCS for the downlink transmission.

In some aspects, the base station 704 may receive recommended SCSs from multiple UEs, and may determine the SCS for the downlink transmission based on the multiple recommended SCSs. For example, in some aspects, the base station 704 may determine to use the widest recommended SCS received from a UE in the same band or sub-band as the UE 702 as the SCS for the downlink transmission to the UE 702. In some aspects, the base station 704 may transmit the determined SCS 718 to the UE 702.

Finally, the base station 704 may transmit the downlink transmission 720 to the UE 702 using the determined MCS 710 and the SCS determined at 716 (e.g., the recommended SCS), and the UE 702 may receive the downlink transmission 720 using the determined MCS 710 and the SCS determined at 716. The UE 702 may receive the downlink transmission 720 and may perform phase noise suppression utilizing the number of ICI correction coefficients determined at 707.

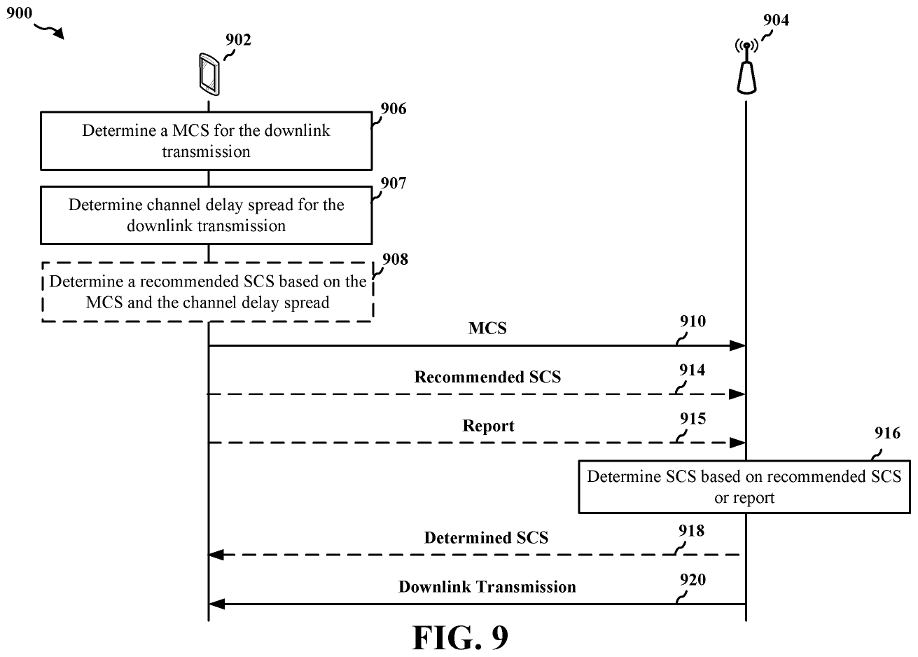

FIG. 9 is a communication flow diagram 900 illustrating dynamic numerology in downlink communication based on channel delay spread. A channel may have a delay spread, and a transmission on the channel may include a cyclic prefix to mitigate the display spread. To cope with a more dispersive channel (e.g., a channel with a longer delay spread), a longer cyclic prefix may be used.

Cyclic prefix overhead is the ratio of the length of the cyclic prefix (Tcp) to the length of the cyclic prefix plus the symbol duration (Tsym) (e.g., cyclic prefix overhead=Tcp/(Tcp+Tsym)). The symbol duration is inversely proportional to the subcarrier spacing (e.g., Tsym=1/SCS). A channel with a narrower SCS may have a longer symbol duration, and may therefore have a lower cyclic prefix overhead. Accordingly, a transmission with narrower SCS may be able to address a dispersive channel with a lower increase in cyclic prefix overhead.

A base station 904 may be attempting to transmit a downlink transmission to a UE 902. As illustrated at 906, the UE 902 may determine a MCS to use for the downlink transmission. For example, the UE 902 may determine the noise floor for the channel on which the downlink transmission will be sent, and may select a MCS by comparing the target noise floor of the MCS to the noise floor for the channel (e.g., may select a MCS with a target noise floor that is above the noise floor for the channel, or may select a MCS with a target noise floor that is at least a threshold level above the noise floor for the channel). The UE 902 may transmit the determined MCS 910 to the base station 904.

As illustrated at 909, the UE 902 may determine a channel delay spread for the channel on which the downlink transmission will be transmitted. For example, the UE 902 (e.g., a modem of the UE 902) may measure a maximum delay spread for the channel by measuring a time gap between a first tap and a last tap of a channel response. As another example, the UE 902 may measure a root-mean-squared delay spread by calculating the average delay spread on the channel and then calculating the variance around that average delay spread.

In some aspects, as illustrated at 908, the UE 902 may determine a recommended SCS based on the MCS determined at 906 and the channel delay spread determined at 908. The recommended SCS may be determined based on whether the noise floor or the phase noise floor that would remain after phase noise suppression would be below the target noise floor for the MCS (or would be at least a threshold value below the target noise floor), and based on whether that SCS would provide a cyclic prefix overhead below a target cyclic prefix overhead value if the cyclic prefix length was changed based on the channel delay spread determined at 907. In some aspects, the UE 902 may determine a recommended SCS which would satisfy the noise floor requirements of the MCS and which would result in a cyclic prefix overhead below the target cyclic prefix overhead value.

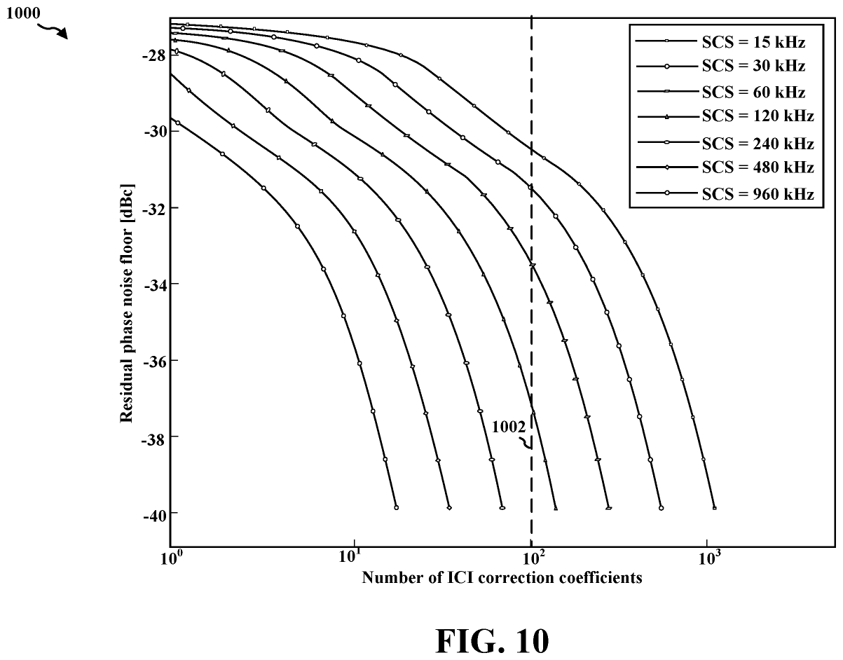

For example, FIG. 10 is a graph 1000 showing the residual phase noise floor on a channel for a receiver based on the number of ICI correction coefficients used and the subcarrier spacing of the channel. The UE 902 may be configured to utilize 100 ICI correction coefficients in phase noise suppression. Line 1002 illustrates the residual phase noise floor after phase noise suppression which the UE 902 will expect for various SCSs. If a residual phase noise of −32 dBc or lower would satisfy the target noise floor for the MCS, the UE 902 may select 960 kHz or 480 kHz as eligible SCSs. The UE 902 may determine that when the cyclic prefix length is adjusted based on the channel delay spread determined at 907, a SCS of 480 kHz or narrower would result in a cyclic prefix overhead which is below the target cyclic prefix overhead value and a SCS wider than 480 kHz would result in a cyclic prefix overhead which is above the target cyclic prefix overhead value. Accordingly, of the eligible SCSs, (e.g., 960 kHz or 480 kHz), the UE 902 may select 480 kHz as the recommended subcarrier spacing.

In some aspects, where there are no SCSs which would satisfy both the target cyclic prefix overhead and the MCS noise floor, the UE 902 may select a different MCS for the downlink transmission.

In some aspects, the UE 902 may additionally be configured to use a variable number of ICI correction coefficients, and the UE 902 may further determine a number of ICI correction coefficients to use for the downlink transmission and may consider the number of ICI correction coefficients in selecting the recommended SCS, for example as described above with respect to 708 of FIG. 7 and with respect to FIG. 8.

In aspects where the UE 902 determines a recommended SCS, the UE 902 may transmit the recommended SCS 914 to the base station 916.

In some aspects, instead of the UE 902 sending a recommended SCS, the UE 902 may report all of the relevant information to the base station 904 and the base station 904 may determine the SCS based on the information. The UE 902 may transmit a report 915 to the base station 904. The report 915 may include the thermal noise for the channel on which the downlink transmission will be transmitted, the phase noise level of the channel, and the channel delay spread of the channel. In some aspects, the report 915 may also include an ICI correction coefficient configuration. The ICI correction coefficient configuration may identify the number of ICI correction coefficients which the UE 902 will use for phase noise suppression and/or the configuration of UE 902 to utilize a variable number of ICI correction coefficients (e.g., a range of coefficients). The base station 904 may then determine a SCS for the downlink transmission in the same manner as was described for the UE 902 with respect to 908.

As illustrated at 916, the base station 904 may determine a SCS that will be used for the downlink transmission. In some aspects, the base station 904 may receive the recommended SCS 914 and may select the SCS that will be used for the downlink transmission based on the recommended SCS 914, and/or may select the recommended SCS 914 as the SCS that will be used for the downlink transmission. The recommended SCS 914, especially when being discussed from the perspective of the base station 904, may also be referred to a candidate SCS. In some aspects, the base station 904 may receive the report 915 and may determine the SCS that will be used for the downlink transmission based on the information in the report 915. The base station 904 may transmit the determined SCS 918 to the UE 902. The base station 904 may transmit the downlink transmission 920 to the UE 902 using the determined MCS 910 and the SCS determined at 916. The UE 902 may receive the downlink transmission 920 using the determined MCS 910 and the SCS determined at 916.

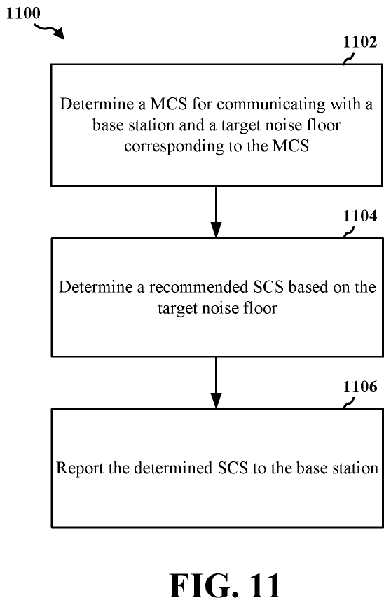

FIG. 11 is a flowchart 1100 of a method of wireless communication. The method may be performed by a UE (e.g., the UE 104, 502, 702, 902; the apparatus 1402).

At 1102, the UE may determine a modulation and coding scheme for communicating with a base station and a target noise floor corresponding to the modulation and coding scheme. For example, 1102 may be performed by the MCS scheme determination component 1440 described below. Aspects of 1102 are also described with reference to FIGS. 5, 7, and 9, and more specifically, with reference to 506, 706, and 906.

At 1104, the UE may determine a recommended subcarrier spacing based on the target noise floor. For example, 1104 may be performed by the recommended SCS determination component 1442 described below. The target noise floor can include a channel estimation noise floor contribution and a residual phase noise floor contribution. In some aspects, the UE may determine a residual phase noise floor corresponding to a candidate subcarrier spacing and determine whether the residual phase noise floor is below the target noise floor. In some aspects, the UE may determine a residual phase noise floor corresponding to the candidate subcarrier spacing and determine that the residual phase noise floor is at least a threshold value below the target noise floor, and, responsive to such a determination, determine the candidate subcarrier spacing as the recommended subcarrier spacing. Additionally or alternatively, the UE may determine the residual phase noise floor corresponding to the candidate subcarrier spacing and determine that the total of the channel estimation noise floor and the residual phase noise floor is, for example, at least a threshold value below the target noise floor. Aspects of 1104 are also described with reference to FIGS. 5, 7, and 9, and more specifically, with reference to 508, 707, and 908.

In some aspects, the recommended subcarrier spacing is determined based on a number of inter carrier interference correction coefficients to utilize in phase noise correction. In some aspects, the UE may determine the number of inter carrier interference correction coefficients to utilize in phase noise correction, determine a residual phase noise floor corresponding to the recommended subcarrier spacing based on the number of inter carrier interference correction coefficients, and determine that the residual phase noise floor is below the target noise floor.

In some aspects, the modulation and coding scheme may be for communicating with the base station on a channel, and the recommended subcarrier spacing may be determined based on a channel delay spread of the channel. The channel delay spread can have an associated channel estimation noise floor contribution to a total noise floor. As such, the UE may determine the channel estimation noise floor corresponding to a candidate subcarrier spacing and determine that the total of the channel estimation noise floor and the residual phase noise floor is, for example, at least a threshold value below the target noise floor. In some aspects, the recommended subcarrier spacing may be determined based on a number of inter carrier interference correction coefficients to utilize in phase noise correction. The inter carrier interference correction coefficients can have an associated residual phase noise floor contribution to the total noise floor. In some aspects, the UE may determine a cyclic prefix overhead value corresponding to the recommended subcarrier spacing based on the channel delay spread, and determine that the cyclic prefix overhead value is below a target cyclic prefix overhead value.

At 1106, the UE may report the determined recommended subcarrier spacing to the base station. For example, 1106 may be performed by the recommended SCS reporting component 1444 described below. Aspects of 1106 are also described with reference to FIGS. 5, 7, and 9, and more specifically, with reference to 514, 714, and 914.

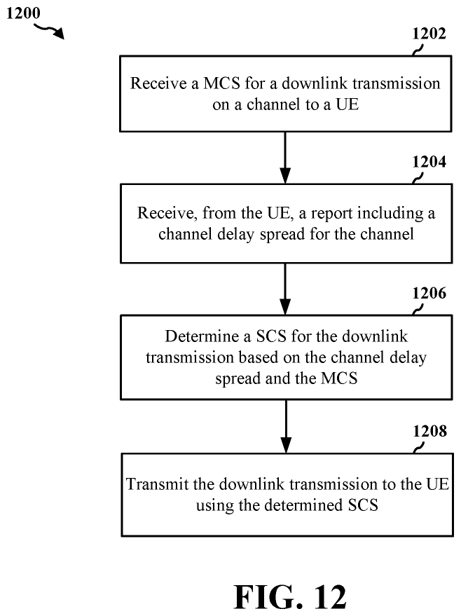

FIG. 12 is a flowchart 1200 of a method of wireless communication. The method may be performed by a base station (e.g., the base station 102/180, 504, 704, 904; the apparatus 1502).

At 1202, the base station may receive, from a user equipment (UE), a modulation and coding scheme for a downlink transmission on a channel to the UE. For example, 1202 may be performed by the MCS reception component 1540 described below. Aspects of 1202 are also described with reference to FIGS. 5, 7, and 9, and more specifically, with reference to 510, 710, and 910.

At 1204, the base station may receive, from the UE, a report comprising a channel delay spread for the channel. For example, 1204 may be performed by the channel delay spread report reception component 1542 described below. Aspects of 1204 are also described with reference to FIG. 9, and more specifically, with reference to 915.

At 1206, the base station may determine a subcarrier spacing for the downlink transmission based on the channel delay spread and the modulation and coding scheme. For example, 1206 may be performed by the SCS determination component 1546 described below. In some aspects, the base station may receive a candidate subcarrier spacing from the UE. The base station may further determine the subcarrier spacing for the downlink transmission based on the recommended subcarrier spacing. Aspects of 1206 are also described with reference to FIGS. 5, 7, and 9, and more specifically, with reference to 516, 716, and 916.

The candidate subcarrier spacing may be based on a residual phase noise floor corresponding to the candidate subcarrier spacing or a number of inter carrier interference correction coefficients for the UE. The base station may transmit the determined subcarrier spacing to the UE.

Determining the subcarrier spacing for the downlink transmission may include determining a cyclic prefix overhead value corresponding to the subcarrier spacing based on the channel delay spread, and determining that the cyclic prefix overhead value is below a target cyclic prefix overhead value.

The base station may receiving a phase noise floor corresponding to the subcarrier spacing from the UE, and may determine the subcarrier spacing for the downlink transmission further based on the phase noise floor corresponding to the subcarrier spacing from the UE.

The base station may receive an inter carrier interference correction coefficient configuration from the UE, and may determine the subcarrier spacing for the downlink transmission further based on the inter carrier interference correction coefficient configuration. The inter carrier interference correction coefficient configuration may indicate a number of inter carrier interference correction coefficients that the UE will use or may indicate a range of inter carrier interference correction coefficients that the UE is configured to use. The base station may further determine a number of inter carrier interference correction coefficients for the UE based on the inter carrier interference correction coefficient configuration and the determined subcarrier spacing (e.g., selected from the range of inter carrier interference correction coefficients), and may transmit the number of inter carrier interference correction coefficients to the UE.

At 1208, the base station may transmit the downlink transmission to the UE using the determined subcarrier spacing. For example, 1208 may be performed by the downlink transmission component 1548 described below. Aspects of 1208 are also described with reference to FIGS. 5, 7, and 9, and more specifically, with reference to 520, 720, and 920.

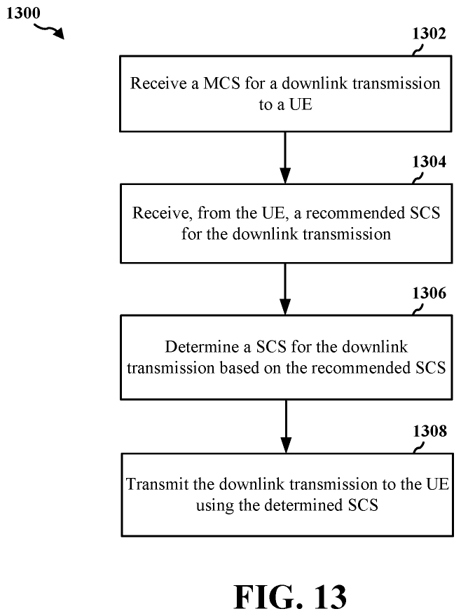

FIG. 13 is a flowchart 1300 of a method of wireless communication. The method may be performed by a base station (e.g., the base station 102/180, 504, 704, 904; the apparatus 1502).

At 1302, the base station may receive, from a user equipment (UE), a modulation and coding scheme for a downlink transmission to the UE. For example, 1302 may be performed by the MCS reception component 1540 described below. Aspects of 1302 are also described with reference to FIGS. 5, 7, and 9, and more specifically, with reference to 510, 710, and 910.

At 1304, the base station may receive, from the UE, a recommended subcarrier spacing for the downlink transmission. For example, 1304 may be performed by the recommended SCS reception component 1544 described below. Aspects of 1304 are also described with reference to FIGS. 5, 7, and 9, and more specifically, with reference to 514, 714, and 914.

At 1306, the base station may determine a subcarrier spacing for the downlink transmission based on the recommended subcarrier spacing. For example, 1306 may be performed by the SCS determination component 1546 described below. In some aspects, the base station may determine to use the recommended subcarrier spacing as the subcarrier spacing for the downlink transmission. Aspects of 1306 are also described with reference to FIGS. 5, 7, and 9, and more specifically, with reference to 516, 716, and 916.

At 1308, the base station may transmit the downlink transmission to the UE using the determined subcarrier spacing. For example, 1308 may be performed by the downlink transmission component 1548 described below. Aspects of 1308 are also described with reference to FIGS. 5, 7, and 9, and more specifically, with reference to 520, 720, and 920.

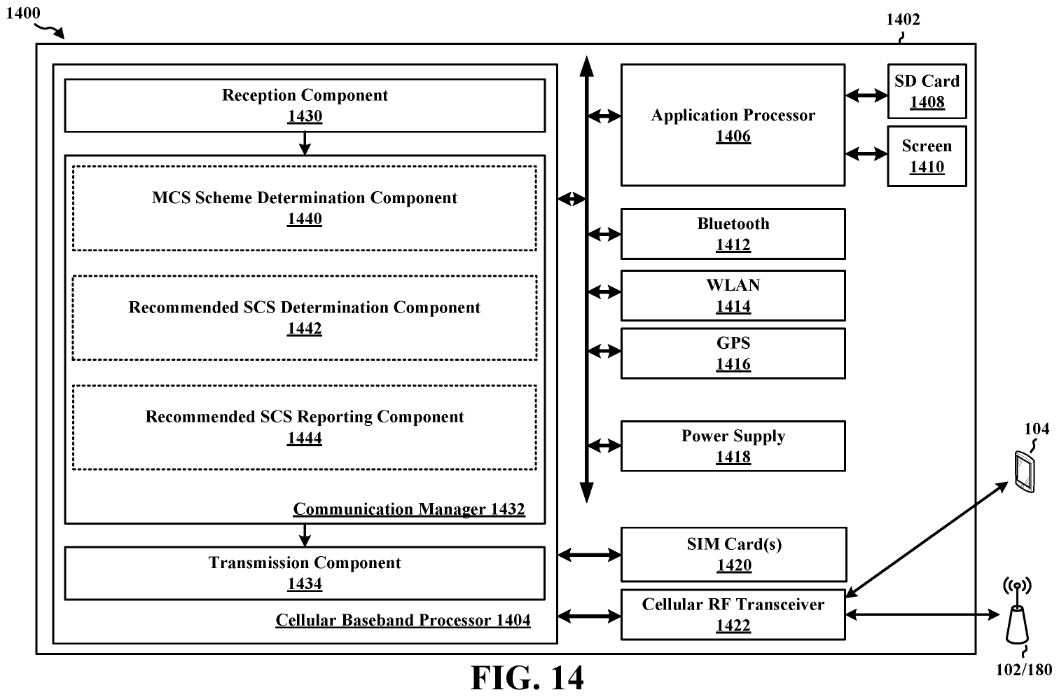

FIG. 14 is a diagram 1400 illustrating an example of a hardware implementation for an apparatus 1402. The apparatus 1402 is a UE and includes a cellular baseband processor 1404 (also referred to as a modem) coupled to a cellular RF transceiver 1422 and one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, and a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 350 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., see 350 of FIG. 3) and include the additional modules of the apparatus 1402 discussed above.

The communication manager 1432 includes a MCS determination component 1440 that is configured to determine a modulation and coding scheme for communicating with a base station and a target noise floor corresponding to the modulation and coding scheme, e.g., as described in connection with block 1102 of FIG. 11. The communication manager 1432 further includes a recommended SCS determination component 1442 that receives input in the form of a target noise floor from the MCS determination component 1440 and is configured to determine a recommended subcarrier spacing based on the target noise floor, e.g., as described in connection with block 1104 of FIG. 11. The communication manager 1432 further includes a recommended SCS reporting component 1444 that receives input in the form of a recommended subcarrier spacing from the recommended SCS determination component 1442 and is configured to report the determined subcarrier spacing to the base station, for example using the transmission component 1434, e.g., as described in connection with block 1106 of FIG. 11.

The apparatus may include additional components that perform each of the blocks of the algorithm in the aforementioned flowchart of FIG. 11. As such, each block in the aforementioned flowchart of FIG. 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1402, and in particular the cellular baseband processor 1404, includes means for determining a modulation and coding scheme for communicating with a base station and a target noise floor corresponding to the modulation and coding scheme, means for determining a recommended subcarrier spacing based on the target noise floor, and means for reporting the determined subcarrier spacing to the base station. The aforementioned means may be one or more of the aforementioned components of the apparatus 1402 configured to perform the functions recited by the aforementioned means. As described supra, the apparatus 1402 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

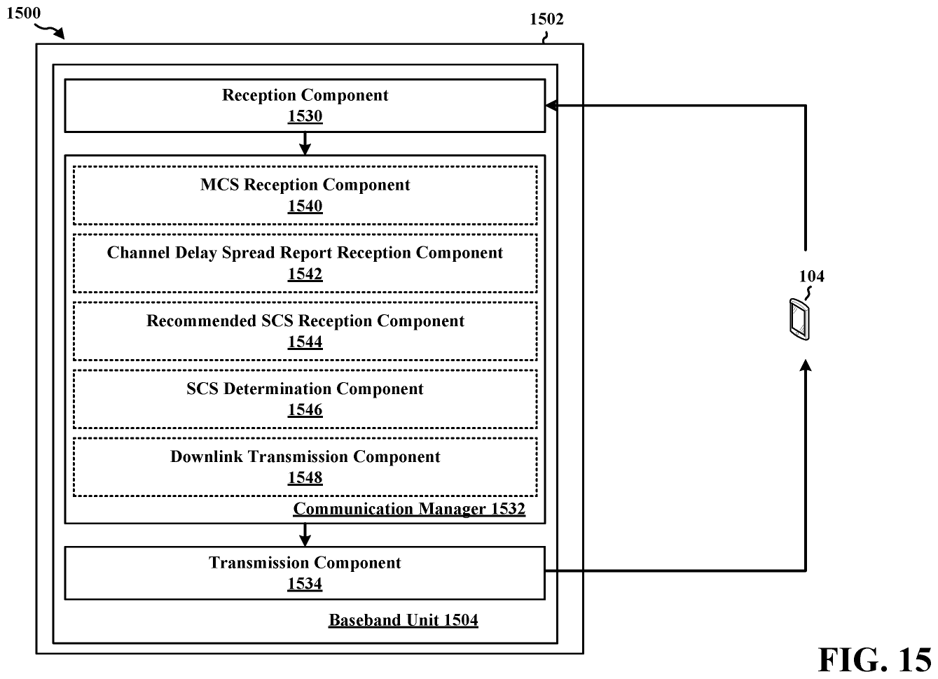

FIG. 15 is a diagram 1500 illustrating an example of a hardware implementation for an apparatus 1502. The apparatus 1502 is a BS and includes a baseband unit 1504. The baseband unit 1504 may communicate through a cellular RF transceiver with the UE 104. The baseband unit 1504 may include a computer-readable medium/memory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504. The baseband unit 1504 may be a component of the BS 310 and may include the memory 376 and/or at least one of the TX processor 316, the RX processor 370, and the controller/processor 375.

The communication manager 1532 includes a MCS reception component 1540 that receives, from a UE, a modulation and coding scheme for a downlink transmission on a channel to the UE, e.g., as described in connection with block 1202 of FIG. 12 or block 1302 of FIG. 13. In some aspects, the communication manager 1532 further includes a channel delay spread report reception component 1542 that receives, from the UE, a report comprising a channel delay spread for the channel, e.g., as described in connection with 1204 of FIG. 12. In some aspects, the communication manager 1532 further includes a recommended SCS reception component 1544 that receives, from the UE, a recommended subcarrier spacing for the downlink transmission, e.g., as described in connection with 1304 of FIG. 13. The communication manager 1532 further includes a SCS determination component 1546. In some aspects, the SCS determination component 1546 determines a subcarrier spacing for the downlink transmission based on the channel delay spread and the modulation and coding scheme, e.g., as described in connection with 1206 of FIG. 12. In some aspects, the SCS determination component 1546 determines a subcarrier spacing for the downlink transmission based on the recommended subcarrier spacing, e.g., as described in connection with 1306 of FIG. 13. The communication manager 1532 further includes a downlink component 1548 that transmits the downlink transmission to the UE using the determined subcarrier spacing, for example using the transmission component 1534, e.g., as described in connection with block 1208 of FIG. 12 or block 1308 of FIG. 13.

The apparatus may include additional components that perform each of the blocks of the algorithm in the aforementioned flowcharts of FIGS. 12 and 13. As such, each block in the aforementioned flowcharts of FIGS. 12 and 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1502, and in particular the baseband unit 1504, includes means for receiving, from a user equipment (UE), a modulation and coding scheme for a downlink transmission on a channel to the UE, means for receiving, from the UE, a report comprising a channel delay spread for the channel, means for determining a subcarrier spacing for the downlink transmission based on the channel delay spread and the modulation and coding scheme, and means for transmitting the downlink transmission to the UE using the determined subcarrier spacing. In one configuration, the apparatus 1502, and in particular the baseband unit 1504, includes means for receiving, from a UE, a modulation and coding scheme for a downlink transmission to the UE, means for receiving, from the UE, a recommended subcarrier spacing for the downlink transmission, means for determining a subcarrier spacing for the downlink transmission based on the recommended subcarrier spacing, and means for transmitting the downlink transmission to the UE using the determined subcarrier spacing. The aforementioned means may be one or more of the aforementioned components of the apparatus 1502 configured to perform the functions recited by the aforementioned means. As described supra, the apparatus 1502 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is a method of wireless communication at a user equipment (UE), comprising determining a modulation and coding scheme for communicating with a base station and a target noise floor corresponding to the modulation and coding scheme; determining a recommended subcarrier spacing based on the target noise floor; and reporting the determined recommended subcarrier spacing to the base station.

Example 2 is the method of Example 1, wherein determining the recommended subcarrier spacing comprises determining a residual phase noise floor corresponding to the recommended subcarrier spacing; and determining that the residual phase noise floor is below the target noise floor.

Example 3 is the method of any of Examples 1 and 2, wherein determining the recommended subcarrier spacing comprises determining a residual phase noise floor corresponding to the recommended subcarrier spacing; and determining that the residual phase noise floor is at least a threshold value below the target noise floor.

Example 4 is the method of any of Examples 1 to 3, wherein determining the recommended subcarrier spacing comprises: determining a number of inter carrier interference correction coefficients to utilize in phase noise correction; determining a residual phase noise floor corresponding to the recommended subcarrier spacing based on the number of inter carrier interference correction coefficients; and determining that the residual phase noise floor is below the target noise floor.

Example 5 is the method of any of Examples 1 to 4, wherein determining the recommended subcarrier spacing based on the target noise floor comprises determining the recommended subcarrier spacing based on a channel estimation noise floor associated with a channel delay spread of a channel, wherein the modulation and coding scheme is for communicating with the base station on the channel.

Example 6 is the method of any of Examples 1 to 5, wherein determining the recommended subcarrier spacing based on the target noise floor comprises determining the recommended subcarrier spacing further based on a number of inter carrier interference correction coefficients to utilize in phase noise correction.

Example 7 is the method of any of Examples 1 to 6, wherein determining the recommended subcarrier spacing comprises determining a cyclic prefix overhead value corresponding to the recommended subcarrier spacing based on the channel delay spread; and determining that the cyclic prefix overhead value is below a target cyclic prefix overhead value.

Example 8 is an apparatus for wireless communication at a user equipment (UE) comprising a memory; and at least one processor coupled to the memory and configured to determine a modulation and coding scheme for communicating with a base station and a target noise floor corresponding to the modulation and coding scheme; determine a recommended subcarrier spacing based on the target noise floor; and report the determined recommended subcarrier spacing to the base station.

Example 9 is the apparatus of Example 8, wherein determining the recommended subcarrier spacing comprises determining a residual phase noise floor corresponding to the recommended subcarrier spacing; and determining that the residual phase noise floor is below the target noise floor.

Example 10 is the apparatus of any of Examples 8 and 9, wherein determining the recommended subcarrier spacing comprises determining a residual phase noise floor corresponding to the recommended subcarrier spacing; and determining that the residual phase noise floor is at least a threshold value below the target noise floor.

Example 11 is the apparatus of any of Examples 8 to 10, wherein determining the recommended subcarrier spacing comprises determining a number of inter carrier interference correction coefficients to utilize in phase noise correction; determining a residual phase noise floor corresponding to the recommended subcarrier spacing based on the number of inter carrier interference correction coefficients; and determining that the residual phase noise floor is below the target noise floor.

Example 12 is the apparatus of any of Examples 8 to 11, wherein determining the recommended subcarrier spacing comprises determining a cyclic prefix overhead value corresponding to the recommended subcarrier spacing based on a channel delay spread of a channel, wherein the modulation and coding scheme is for communicating with the base station on the channel; and determining that the cyclic prefix overhead value is below a target cyclic prefix overhead value.

Example 13 is a method of wireless communication at a base station, comprising receiving, from a user equipment (UE), a modulation and coding scheme for a downlink transmission on a channel to the UE; receiving, from the UE, a report comprising a channel delay spread for the channel; determining a subcarrier spacing for the downlink transmission based on the channel delay spread and the modulation and coding scheme; and transmitting the downlink transmission to the UE using the determined subcarrier spacing.

Example 14 is the method of Example 13, further comprising receiving, from the UE, a candidate subcarrier spacing for the downlink transmission; and determining the subcarrier spacing for the downlink transmission further based on the received candidate subcarrier spacing.

Example 15 is the method of any of Examples 13 and 14, wherein the candidate subcarrier spacing is based on a residual phase noise floor corresponding to the candidate subcarrier spacing or a number of inter carrier interference correction coefficients for the UE.

Example 16 is the method of any of Examples 13 to 15, further comprising transmitting the determined subcarrier spacing to the UE.

Example 17 is the method of any of Examples 13 to 16, wherein determining the subcarrier spacing for the downlink transmission comprises determining a cyclic prefix overhead value corresponding to the subcarrier spacing based on the channel delay spread; and determining that the cyclic prefix overhead value is below a target cyclic prefix overhead value.

Example 18 is the method of any of Examples 13 to 17, further comprising receiving a phase noise floor corresponding to the subcarrier spacing from the UE; and determining the subcarrier spacing for the downlink transmission further based on the phase noise floor corresponding to the subcarrier spacing from the UE.

Example 19 is the method of any of Examples 13 to 18, further comprising receiving an inter carrier interference correction coefficient configuration from the UE; and determining the subcarrier spacing for the downlink transmission further based on the inter carrier interference correction coefficient configuration.

Example 20 is the method of any of Examples 13 to 19, further comprising determining a number of inter carrier interference correction coefficients for the UE based on the inter carrier interference correction coefficient configuration and the determined subcarrier spacing; and transmitting the number of inter carrier interference correction coefficients to the UE.

What is claimed is:

1. A method of wireless communication at a user equipment (UE), comprising:
determining a modulation and coding scheme for communicating with a base station and a target noise floor corresponding to the modulation and coding scheme;
determining a recommended subcarrier spacing based on the target noise floor; and
reporting the determined recommended subcarrier spacing to the base station.

2. The method of claim 1, wherein determining the recommended subcarrier spacing comprises:
determining a residual phase noise floor corresponding to the recommended subcarrier spacing; and
determining that the residual phase noise floor is below the target noise floor.

3. The method of claim 1, wherein determining the recommended subcarrier spacing comprises:
determining a residual phase noise floor corresponding to the recommended subcarrier spacing; and
determining that the residual phase noise floor is at least a threshold value below the target noise floor.

4. The method of claim 1, wherein determining the recommended subcarrier spacing comprises:
determining a number of inter carrier interference correction coefficients to utilize in phase noise correction;
determining a residual phase noise floor corresponding to the recommended subcarrier spacing based on the number of inter carrier interference correction coefficients; and
determining that the residual phase noise floor is below the target noise floor.

5. The method of claim 1, wherein determining the recommended subcarrier spacing based on the target noise floor comprises:
determining the recommended subcarrier spacing based on a channel estimation noise floor associated with a channel delay spread of a channel, wherein the modulation and coding scheme is for communicating with the base station on the channel.

6. The method of claim 5, wherein determining the recommended subcarrier spacing based on the target noise floor comprises:
determining the recommended subcarrier spacing further based on a number of inter carrier interference correction coefficients to utilize in phase noise correction.

7. The method of claim 5, wherein determining the recommended subcarrier spacing comprises:
determining a cyclic prefix overhead value corresponding to the recommended subcarrier spacing based on the channel delay spread; and
determining that the cyclic prefix overhead value is below a target cyclic prefix overhead value.

8. An apparatus for wireless communication at a user equipment (UE) comprising:
a memory; and
at least one processor coupled to the memory and configured to:
determine a modulation and coding scheme for communicating with a base station and a target noise floor corresponding to the modulation and coding scheme;
determine a recommended subcarrier spacing based on the target noise floor; and
report the determined recommended subcarrier spacing to the base station.

9. The apparatus of claim 8, wherein determining the recommended subcarrier spacing comprises:
determining a residual phase noise floor corresponding to the recommended subcarrier spacing; and
determining that the residual phase noise floor is below the target noise floor.

10. The apparatus of claim 8, wherein determining the recommended subcarrier spacing comprises:
determining a residual phase noise floor corresponding to the recommended subcarrier spacing; and
determining that the residual phase noise floor is at least a threshold value below the target noise floor.

11. The apparatus of claim 8, wherein determining the recommended subcarrier spacing comprises:
determining a number of inter carrier interference correction coefficients to utilize in phase noise correction;
determining a residual phase noise floor corresponding to the recommended subcarrier spacing based on the number of inter carrier interference correction coefficients; and
determining that the residual phase noise floor is below the target noise floor.

12. The apparatus of claim 8, wherein determining the recommended subcarrier spacing comprises:
determining a cyclic prefix overhead value corresponding to the recommended subcarrier spacing based on a channel delay spread of a channel, wherein the modulation and coding scheme is for communicating with the base station on the channel; and
determining that the cyclic prefix overhead value is below a target cyclic prefix overhead value.

13. A method of wireless communication at a base station, comprising:
receiving, from a user equipment (UE), a modulation and coding scheme for a downlink transmission on a channel to the UE;
receiving, from the UE, a report comprising a channel delay spread for the channel;
determining a subcarrier spacing for the downlink transmission based on the channel delay spread and the modulation and coding scheme; and
transmitting the downlink transmission to the UE using the determined subcarrier spacing.

14. The method of claim 13, further comprising:
receiving, from the UE, a candidate subcarrier spacing for the downlink transmission; and
determining the subcarrier spacing for the downlink transmission further based on the received candidate subcarrier spacing.

15. The method of claim 14, wherein the candidate subcarrier spacing is based on a residual phase noise floor corresponding to the candidate subcarrier spacing or a number of inter carrier interference correction coefficients for the UE.

16. The method of claim 14, further comprising transmitting the determined subcarrier spacing to the UE.

17. The method of claim 13, wherein determining the subcarrier spacing for the downlink transmission comprises:
determining a cyclic prefix overhead value corresponding to the subcarrier spacing based on the channel delay spread; and
determining that the cyclic prefix overhead value is below a target cyclic prefix overhead value.

18. The method of claim 13, further comprising:
receiving a phase noise floor corresponding to the subcarrier spacing from the UE; and
determining the subcarrier spacing for the downlink transmission further based on the phase noise floor corresponding to the subcarrier spacing from the UE.

19. The method of claim 13, further comprising:
receiving an inter carrier interference correction coefficient configuration from the UE; and
determining the subcarrier spacing for the downlink transmission further based on the inter carrier interference correction coefficient configuration.

20. The method of claim 19, further comprising:
determining a number of inter carrier interference correction coefficients for the UE based on the inter carrier interference correction coefficient configuration and the determined subcarrier spacing; and
transmitting the number of inter carrier interference correction coefficients to the UE.
